(19) United States
(12) Patent Application Publication
(10) Pub. No.: US 2010/0292863 A1
(43) Pub. Date: Nov. 18, 2010

(54) CONTROL SYSTEM AND A METHOD OF CONTROLLING A TCSC IN AN ELECTRICAL TRANSMISSION NETWORK, IN PARTICULAR BY AN APPROACH USING SLIDING MODES

(75) Inventors: Abdelkrim Benchaib, Montigny Le Bretonneux (FR); Serge Poullain, Arpajon (FR); Yannick Weiler, Paris (FR)

Correspondence Address: Nixon Peabody LLP, P.O. Box 60610, Palo Alto, CA, 94306, US

(73) Assignee: AREVA T&D SAS, Paris La Defense Cedex (FR)

(21) Appl. No.: 12/597,480

(22) PCT Filed: Apr. 22, 2008
(86) PCT No.: PCT/EP08/54847

§ 371 Date: Mar. 22, 2010

(30) Foreign Application Priority Data
Apr. 24, 2007 (FR) 0754659

(51) Int. Cl. G06F 1/28

(52) U.S. Cl. 700/298

(57) ABSTRACT

A system and method of controlling a TCSC disposed on a high voltage line of an electrical transmission network. The system comprises: (a) a voltage measuring module; (b) a current measuring module; (c) a regulator, working in accordance with a non-linear control law to receive on its input the output signals from the two modules for measuring voltage and current, and a reference voltage corresponding to the fundamental of the voltage which is to obtained across the TCSC; (d) a module for extracting the control angle in accordance with an extraction algorithm; and (e) a module for controlling the thyristors (T1, T2) of the TCSC, and for receiving a zero current reference delivered by a phase-locked loop which gives the position of the current.

### CROSS REFERENCE TO RELATED APPLICATIONS OR PRIORITY CLAIM

This application is a national phase of International Application No. PCT/EP2008/054847, entitled “CONTROL SYSTEM AND METHOD FOR A TCSC IN AN ELECTRIC ENERGY TRANSPORT NETWORK IN PARTICULAR USING A SLIDING-MODE APPROACH”, which was filed on Apr. 22, 2008, and which claims priority of French Patent Application No. 07 54659, filed Apr. 24, 2007.

### DESCRIPTION

1. Technical Field

This invention relates to a control system and to a method of controlling a TCSC in an electrical transmission network, in particular by an approach using sliding modes.

2. Current State of the Prior Art

The prevailing steady growth in the demand for electricity is saturating the great power transmission and distribution grids. The opening up of the market for electric power in Europe, which is of major importance economically, does however raise a large number of problems, and in particular it points to the importance of connecting national grids to one another, with those grids on which there is less demand being thereby able to support the ones which are more heavily loaded. The major blackouts (due to breakdown of the distribution network or loss of synchronism) which occurred in the United States and in Europe (Italy) in the course of the year 2003, as a result of very high power demand, made the appropriate authorities aware of the need to develop the networks in parallel with the development in the demand for power. But then, maximization of power transfer becomes a new constraint that has to be taken into account. Management and control of the production units, regulation, and capacities that can be varied using mechanical interrupters have been the principal methods employed for control of the flow of power. However, there do exist applications requiring continuous control, which would be impossible with such methods. Flexible alternating current transmission systems (FACTS) can respond adequately to these new requirements, by controlling reactive power. Among these systems, and in spite of recent technological advances, the thyristor controlled series capacitor or TCSC remains the solution that offers the best compromise between economic and technical criteria. Besides controlling reactive power, it enables the stability of the network to be increased, in particular in the presence of hypo-synchronous resonance phenomena.

### The Principle of Power Transfer

In an energy transport network, electricity is generated by the alternators as three-phase alternating current (AC), and the voltage is then increased by step-up transformers to very high voltages before being transmitted over the network. The very high voltage enables power to be transported over long distances, while lightening the structures of the network and reducing heating losses. Voltage does however remain limited by the constraints of the need to isolate the various items of equipment, and also by electromagnetic radiation effects. The range of voltage which offers a good compromise is from 400 kilovolts (kV) to 800 kV.

In order for power to be able to pass between a source and a receiver it is necessary for the voltage of the source to be out of phase relative to the receiver voltage, by an angle θ. This angle θ is called the internal angle of the line or the transmission angle.

If Vs is the voltage on the source side, Vr the voltage on the receiver side, and X1 the purely inductive impedance of the line, then the active power P and reactive power Q provided by the source are expressed by the following expressions respectively:

$$P = \frac{{V}_{s} {V}_{r}}{X 1} sin θ$$

$$Q = \frac{{V}_{s}^{2} - {V}_{s} {V}_{r} cos θ}{X 1}$$

$${P}_{max} = \frac{{V}_{s} {V}_{r}}{X 1}$$

These expressions show that the active power and reactive power transmitted over an inductive line are a function of the voltages Vs and Vr, the impedance X1, and the transmission angle θ.

There are then three possible ways in which the power that can be transmitted over the line may be increased, as follows.

Increase the voltages Vs and Vr. We are then at once limited by the distances needed for isolation purposes and by the dimensioning of the installation. The radiated electromagnetic field is greater. There is therefore an environmental impact to be taken into account. Moreover, the equipment is more expensive and maintenance is costly.

Act on the transmission angle θ. This angle is a function of the active power supplied by the production sites. The maximum angle corresponding to Pₘₐₓ is θ=π/2. For larger angles, we enter into the descending part of the curve P=f(θ), which is an unstable zone. To work with angles θ that are too large is to run the risk of losing control of the network, especially with a transient fault (for example one causing grounding of the phases) on the network where the return to normal operation involves a transient increase in the transmission angle (in order to evacuate the energy which was produced during the fault condition, which could not be used by the load, and which has been stored in the form of kinetic energy in the rotors of the generators). It is therefore important that the angle should not exceed the limit of stability.

Act on the value of the impedance X1, which can be lowered by putting a capacitor in series with the line, thereby compensating for the reactive power which is generated by the power transport line. As the value of the impedance X1 falls, the power that can be transmitted increases for a given transmission angle. Series FACTS equipment consists of appliances that enable this reactive energy compensation function to be achieved. The best known series FACTS device is the fixed capacitor or FC. However, it does not allow the degree of compensation to be adjusted. If such adjustment is required, it is then possible to make use of a TCSC system.

### Use of Series FACTS Equipment for Reactive Power Compensation

The use of FACTS opens up new perspectives for more effective exploitation of power networks with continuous and rapid action on the various parameters of the network, namely phase shifting, voltage, and impedance. Power transfers are thus controlled, and voltage levels maintained, to the best advantage, which enables the margins of stability and level maintenance to be increased with a view to making use of the power lines by transferring the maximum current, at the limit of the thermal strength of these lines, at high and very high voltages.

FACTS can be classified in two families, namely parallel FACTS and series FACTS, as follows:

Parallel FACTS comprise, in particular, the mechanical switched capacitor or MSC, the static Var compensator (SVC), and the static synchronous compensator or STATCOM; and

Series FACTS consist, in particular of the fixed capacitor or FC, the thyristor switch series capacitor or TSSC, the thyristor control series capacitor or TCSC, and the static synchronous series compensator or SSSC.

The most elementary form of series FACTS device consists of a simple capacitor (FC) connected in series on the transmission line. This capacitor partly compensates for the inductance of the line. If Xc is the impedance of this capacitor, and neglecting the resistance of the cables, the power transmitted by the compensated line can be written as:

$$P = \frac{{V}_{s} {V}_{r}}{X l - X c} sin θ$$

### If

$$kc = \frac{Xc}{Xl} ,$$

the amount of compensation of the line, the above expression becomes:

$$P = \frac{{V}_{s} {V}_{r}}{X l ( 1 - k c )} sin θ$$

FIG. 1 shows the variation in active power as a function of the transmission angle, for three different values of the amount of compensation, namely 0% (curve 10), 30% (curve 11), and 60% (curve 12). The improvement made by the series compensation can be clearly seen. In this regard, the amount of compensation acts directly on the value Pₘₐₓ. Thus, the greater the amount of compensation applied, the greater is the amount of power that can be transmitted, or the smaller the transmission angle for a given amount of power to be carried. In addition, the increase in the amount of power that can be transmitted enables the overall stability of the network to be improved in the event of a transient fault in the power transmission line, by producing an increase in the margin of stability (i.e. the margin of active power which is available before reaching the angle that is critical to stability).

However, the association of capacitors having a fixed and constant capacitance with the inductance of the transport line constitutes a resonant system with little damping. In some particular circumstances, especially on returning to normal operation following a fault on the transmission line, this resonant system can go into oscillation through an exchange of energy with the resonant mechanical system consisting of the masses and the shafts of the turbines of the turbo alternators. This energy exchange phenomenon (which is also known as sub-synchronous resonance or SSR) gives rise to oscillations of power (and therefore of electromagnetic torque) of high amplitude, which can sometimes give rise to fracture of the mechanical shafts in the rotating parts of the generators.

In order to damp out these power oscillations, it is accordingly possible to make use of a controllable series capacitor (CSC) for artificially damping the oscillations by active control of the inserted capacitive reactance (and therefore of impedance). Equipment suitable for damping out power oscillations makes use of thyristors to control this reactance. The most commonly used apparatus is the thyristor controlled series capacitor or TCSC, which offers a good solution to the problems of stability in networks, and which is one of the least expensive FACTS devices.

### Use of TCSC Devices for Reactive Power Compensation

As is shown in FIG. 2, a TCSC consists of two parallel branches. The first branch consists of two thyristors T1 and T2 which are connected back to back in series with an inductance L. This branch is called a TCR or thyristor controlled reactor, which can be compared to a variable inductance. The second branch contains only a capacitor C. The variable inductance, which is connected in parallel with the capacitor, enables the impedance of the TCSC to be varied by compensating wholly or partly for the reactive energy produced by the capacitor. The modification of the value of this impedance is obtained by adjusting the trigger angle of the thyristors, i.e. the instant within a period when the thyristors begin to conduct. There is a critical zone corresponding to the resonance of the circuit LC. FIG. 3 enables the overall impedance of the TCSC to be seen as a function of the trigger angle. The zone of resonance 15 can be clearly seen.

The TCSC has two main operating modes, namely the capacitive mode and the inductive mode. The operating mode depends on the value of the trigger angle. Starting of the TCSC can only take place in the capacitive mode.

For a trigger angle greater than the resonance value, the TCSC is in capacitive mode, and the current is in advance of voltage. The TCSC then works as a capacitor and compensates partly for the inductance in the line. FIG. 4 accordingly illustrates operation in capacitive mode, in which the curve 20 represents capacitive mode, the curve 21 represents line current, and curve 22 represents the capacitive voltage (angle β=65°).

The voltage across the capacitor is increased (or boosted) by virtue of a surplus of current arising from the load of the inductance, which is added to the line current when one of the thyristors, for example the thyristor T1, is closed. This increase may be characterized by the ratio Kb=X_{TCSC}/X_{CT}, which is called the boost factor, where X_{CT} is the impedance of the capacitor by itself. During the next half period, the triggering of the other thyristor, for example the thyristor T2, enables the cycle to be reproduced for the opposite phase. The triggering of the thyristors T1 and T2 thus causes a charge/discharge cycle to occur from the inductance towards the capacitor C in each half period. The complete cycle lasts for one full period of the line current. The two thyristors T1 and T2 are controlled in parallel, with one of them being open while the other is closed, and this sequence varies with the alternation of the current.

In an inductive operating mode, the trigger angle is below the resonance value, and the current is retarded relative to the voltage. The order of thyristor triggering is reversed. The voltage is severely deformed by the presence of harmonics which are not insignificant. Accordingly, FIG. 5 shows operation in inductive mode, in which the curve 25 represents capacitive current, curve 26 represents line current, and curve 27 represents capacitive voltage.

TCSCs are mainly used in capacitive mode, but in some particular circumstances they have to work in inductive mode. The change from one mode to the other takes place in response to the thyristors being controlled in a particular way. The transitions are only possible if the time constant of the LC circuit is lower than the period of the network.

In normal operation, the point at which the voltage across the TCSC passes through zero (and therefore the minimum value or maximum value of the current in the TCSC depending on the alternation of the line current) corresponds exactly to the maximum value of the line current, i.e. π/2 for a sinusoidal current. Numerous modeling calculations can be made easier by considering steady conditions. In this regard, the symmetry that results from such an approximation enables the various expressions involved in the modeling exercise to be simplified to a great extent. However, the resulting model is then valid only for steady conditions, which is a great limitation because control is effected by varying the trigger angle.

Once operation becomes transient, that is to say as soon as the trigger angle changes, the symmetry referred to above disappears, and as shown in FIG. 6, a phase shift angle Ø is found between the occurrence of the maximum value of the line current I₁ (see curve 30) and the instant when the voltage v across the TCSC passes through zero (see curve 31), and curve 32 represents the current i in the inductance of the TCSC. The phase shift angle Ø is due to the permanent energy exchanges between the inductance and the capacitance. So long as this angle Ø, which may be seen as a disturbance, remains relatively small, the system is able to damp it out and remain stable. However, higher values of the angle Ø can lead to increasing energy exchanges, thus leading to instability of the system.

The trigger angle α and the end-of-conduction angle τ can be expressed as a function of the phase shift angle Ø, in the following relationships:

$$α = \frac{π}{2} - \frac{σ}{2} + ∅$$

$$τ = \frac{π}{2} + \frac{σ}{2} + ∅$$

### Modeling the TCSC

In what follows, the following assumptions are made:

the thyristors are considered as being ideal, and any non-linearity on opening or closing is ignored;

the thyristors are connected in a simple line connecting a generator delivering to an infinite bus;

the line current is expressed as i₁=I₁ sin(ωₛt) and the instant of maximum current is π/2; and

we are in the sector [α, α+π].

The following notation is introduced:

α: trigger angle of the thyristors;

τ: end-of-conduction angle;

σ=τ−α: duration of conduction;

Ø: phase shift angle;

ω₀: resonant (angular) frequency;

ωₛ: network frequency;

$$S = \frac{{ω}_{0}^{2}}{{ω}_{0}^{2} - {ω}_{s}^{2}} ;$$

$$η = \frac{{ω}_{0}}{{ω}_{s}} , ;$$

L: inductance, R: resistance, C: capacitance of the TCSC;

network frequency: ωₛ=2*50*π;

resonant frequency:

$${ω}_{o} = \frac{1}{\sqrt{LC}} ;$$

root mean square (rms) capacitance:

$${C}_{eff} ( β ) = {\{ \frac{1}{C} - \frac{4}{π} [ \frac{1}{2 C} S ( β + \frac{sin ( 2 β )}{2} ) + {ω}_{s}^{2} {LS}^{2} {cos}^{2} ( β ) ( tan ( β ) - η tan ( ηβ ) ) ] \}}^{- 1} .$$

β: semi-conduction angle

u*=ωₛC_{eff}(β*): equivalent admittance value of the TCSC;

$${v}^{*} = {[ {v}_{1}^{*} , {v}_{2}^{*} ]}^{T} = {[ - \frac{\vert {i}_{l} \vert}{{u}^{*}} , 0 ]}^{T} \text{:}$$

reference voltage;

V₁ and V₂: measured voltages;

V₁* and V₂*: reference voltages,

\tilde{V}₁ and \tilde{V}₂: voltage tracking error

The main objective is to propose a model of the state of the TCSC that is adapted to represent its dynamic behavior over the whole working range. From Kirchhoff's laws and the description of the operation of the TCSC, the equations governing the dynamics of the system are summarized by the following equation system:

$$\{ \begin{matrix}C \frac{d v}{d t} = {i}_{l} - i \\ L \frac{d i}{d t} = qv - Ri\end{matrix}$$

where q is the switching function, such that q=1 for ωₛtε[α, τ], and q=0 for ωₛtε[ρ, π+α].

Since the parameter q can assume two different and discrete values depending on the state of the system, the model obtained is similar to a state model of the “variable structure” or “hybrid” type (i.e. an association of continuous magnitudes and discrete magnitudes). A model of this kind lends itself rather badly to the use of conventional techniques for synthesizing non-linear control laws, except where they address very particular techniques in the control of hybrid systems.

In order to obtain a model that is better adapted, the notion of a phaser is now introduced. The Fourier decomposition into phasers, averaged over a period T, eliminates the need to consider this double structure of the state model.

The generalized average method that is performed here to obtain the model for phaser dynamics is based on the fact that a sinusoid x(.) may be represented over the time interval]t−T, t] with the aid of a Fourier series of the form:

$$x ( τ ) = Re \{ {\sum }_{k \geq 0} {X}_{k} ( t ) {e}^{j k {ω}_{s} τ} \} \\ {ω}_{s} = \frac{2 π}{T} \\ τ ∈ ] t - T , t ]$$

where Re represents the real part, and Xₖ(t) are the complex Fourier coefficients that are also be referred to as phasers. These Fourier coefficients are functions of time, because the time interval considered depends on time (one could speak of a moving window). The k^{h} coefficient (or phaser k) at time t is given by the following average:

$${X}_{k} ( t ) = \frac{c}{T} {\int }_{t - T}^{t} x ( τ ) {e}^{- j k {ω}_{s} τ} d τ$$

$${X}_{k} ( t ) = < x {>}_{k} ( t )$$

where c=1 for k=0 and c=2 for k=>0. A state model is obtained for which the coefficients defined above are state variables.

The sinusoidal function obtained with the Fourier coefficient of index k is called the harmonic function of range k of the function x. This is the function Xₖe^{jkw}^{ₛ}^{τ}. The first harmonic is referred to as the fundamental.

For k=0, the coefficient X₀ is merely the mean value of x.

The derivative of the k^{th} Fourier coefficient is given by the following expression:

$$\frac{d {X}_{k}}{d t} = < \frac{d x}{d t} {>}_{k} - j k {ω}_{s} {X}_{k}$$

It may also be observed that if

$$f ( t + \frac{T}{2} ) = - f ( t ) ,$$

the even harmonics off are zero.

The convention for writing complexes can vary. Most papers relating to the modeling and control of a TCSC have adapted the convention z=a−ib, and not z=a+ib, which is the writing convention used here. However, it should be observed that this choice has no influence whatsoever on the results presented, so long as the decomposition of the complex equations, partly real and partly imaginary, is performed rigorously and stays with the convention adopted from the start. The Fourier transformation in itself remains identical in both cases. The only major difference arises from the sign of ωₛ. In this regard, by adopting the a−ib convention, the orientation of the axis of the imaginary parts is changed, so that rotation of the phasers changes in direction, and ωₛ becomes negative.

Since the static model cannot be made use of and is found to be insufficient, we now try to establish a model that is dynamic concerning voltage and current fundamentals.

Making use of the Fourier decomposition, it is thus possible to establish the dynamics of the phasers of the voltage and current signals.

Starting from the equations that govern the dynamics of voltage and current, given above:

$$\{ \begin{matrix}C \frac{d v}{d t} = {i}_{l} - i \\ L \frac{d i}{d t} = qv - Ri\end{matrix}$$

the Fourier transform is applied, and the following model is then obtained:

$$\{ \begin{matrix}C < \frac{d v}{d t} {>}_{k} = < {i}_{l} {>}_{k} - < i {>}_{k} \\ L < \frac{d i}{d t} {>}_{k} = < qv {>}_{k} - R < i {>}_{k}\end{matrix} \\ with < qv {>}_{k} = \frac{2 {ω}_{s}}{π} {\int }_{α / {ω}_{s}}^{τ / {ω}_{s}} v ( {ω}_{s} t ) {e}^{- j k {ω}_{s} t} d t .$$

From the above expression giving dXt/dt, the above equations become:

$$\{ \begin{matrix}C \frac{d {V}_{k}}{d t} = {I}_{lk} - {I}_{k} - \frac{1}{C} j k {ω}_{s} {V}_{k} \\ L \frac{d {I}_{k}}{d t} = {〈 qv 〉}_{k} - {RI}_{k} - \frac{1}{L} j k {ω}_{s} {I}_{k}\end{matrix}$$

To start with, only the fundamental is considered.

The real parts (cosine) and the imaginary parts (sine) of the fundamentals (or first phasers) of the voltage and current are designated as V1c, V1s, I1c, I1s. We then have:

V₁=V_{1c}+jV₁ₛ

I₁=I_{1c}+jI₁ₛ

It is known that the contribution of the fundamental to the total signal is of the form:

v₁=V_{1c} cos(ωₛt)−V₁ₛ sin(ωₛt)

Thus calculating <qv>₁ gives:

$${〈 qv 〉}_{1} = \frac{1}{π} [ {V}_{1} σ + {\tilde{V}}_{1} sin ( σ ) {e}^{- 2 j ( \frac{π}{2} + φ )} ]$$

In this way a complex state model of the second order is obtained. By separating the real and imaginary parts, a real model of order 4 is obtained, having the following state variables:

$$\{ \begin{matrix}C \frac{d {V}_{1 c}}{d t} = {I}_{11 c} - {I}_{1 c} - \frac{1}{C} {jω}_{s} {V}_{1 s} \\ C \frac{d {V}_{1 s}}{d t} = {I}_{11 s} - {I}_{1 s} - \frac{1}{C} {jω}_{s} {V}_{1 c} \\ \begin{matrix}L \frac{d {I}_{1 c}}{d t} = Re ( {〈 qv 〉}_{1} ) - {RI}_{1 c} - \frac{1}{L} {jω}_{s} {I}_{1 s} & \end{matrix} \\ L \frac{d {I}_{1 s}}{d t} = Im ( {〈 qv 〉}_{1} ) - {RI}_{1 s} - \frac{1}{L} {jω}_{s} {I}_{1 c}\end{matrix}$$

However, if α is controlled, τ depends on the current in the inductance passing through zero, and can be determined by solving a transcendental equation. Consequently, τ does not only depend on V₁, I₁ and I₁. However, some approximations enable the above system to be converted into a true state model. For this purpose it is enough to be able to express Ø as a function of the quantities given above. It is assumed that the signal is sufficiently close in value to the signal obtained with the fundamental alone. Ø can then be expressed as the offset between the fundamental of the line current and the fundamental of the current in the inductance, i.e.:

Ø=arg [−Iₗ·Ī₁]

All the parameters in the model may thus be determined as a function of V₁, I₁, and I₁.

Control laws for the TCSC

The document referenced [1] at the end of this description defines a device for controlling a TCSC in accordance with a control law that is such that the instants when the voltage across the terminals of the capacitor of the TCSC passes through zero are substantially equidistant from one another, even during the periods in which the current passing into the power line contains sub-synchronous components as well as its fundamental component.

A second document in the prior art, that is to say the document with the reference [2], describes a control law which is based on the more general theory of sliding modes, the objective being to find a method of control which enables the fundamental of the voltage to follow the reference V*=[V₁*, 0]^{T}. However, this control law is only valid in the capacitive mode.

An object of the invention is to provide a system and a method of control for a TCSC in a power transmission network, by proposing new control laws for generating the instants at which the thyristors of the said TCSC are triggered, and that work equally well in capacitive mode and in inductive mode.

### SUMMARY OF THE INVENTION

The invention provides a control system for a TCSC disposed on a high voltage line of an electrical transmission network, which comprises:

a voltage measuring module that enables the harmonics of the voltage across the TCSC to be extracted;

a current measuring module that enables the amplitude of the fundamental, and possibly of other harmonics, of the current flowing in the high voltage line to be extracted;

a regulator working in accordance with a non-linear control law, that receives as input the output signals from the two modules measuring voltage and current, and a reference voltage corresponding to the fundamental of the line voltage that is to be obtained across the TCSC, the regulator delivering an equivalent effective admittance;

a module for extracting the control angle in accordance with an extraction algorithm that receives the said equivalent effective admittance and that delivers a control angle; characterized in that it further comprises:

a module for controlling the thyristors of the TCSC, which module receives the said control angle and a zero current reference that is delivered by a phase-locked loop giving the position of the current, and in that the control law is such that:

$$u = \frac{f ( σ ) - sign ( {V}_{1}^{*} ) \vert {i}_{l} \vert}{{V}_{2} + sign ( {V}_{1}^{*} ) ( {V}_{1}^{*} + σ )}$$

where:

the sliding surface σ=\tilde{V}₁−sign(V₁*)V₂ and

f: a linear interpolation function;

V₁ and V₂: measured voltages;

V₁* and V₂*: reference voltages;

\tilde{V}₁ and \tilde{V}₂: voltage tracking error;

Advantageously, we have:

f(σ)=k₁a tan(k₂σ)

k₁=(R|V₂|+δ)

where:

k₁ and k₂ are positive adjustment constants;

δ>0;

R=ωₛ/f( β̅₀);

β̅₀: equilibrium value of β₀;
β₀: control angle;
ωₛ: angular frequency of the network.

Advantageously, the algorithm for extracting the angle comprises a table, or a modelling process, or a binary search.

The invention also provides a method of controlling a TCSC disposed on a high voltage line of an electrical transmission network, which comprises the following steps:

a voltage measuring step that enables the harmonics of the voltage across the TCSC to be extracted;

a current measuring step that enables the amplitude of the fundamental and, optionally, those of any other harmonics in the current flowing in the high voltage line to be extracted;

a step of regulation in accordance with a non-linear control law, making use of the voltage and current measuring signals and a voltage reference signal corresponding to the fundamental of the line voltage that is to be obtained across the TCSC, whereby to obtain an equivalent effective admittance;

a step of extracting the control angle in accordance with an angle extraction algorithm, using the said equivalent effective admittance whereby to obtain a control angle; characterized in that it further comprises:

a step of controlling the thyristors of the TCSC, using the said control angle together with a zero current reference that is delivered by a phase-locked loop giving the position of the current,

and in that the control law is such that:

$$u = \frac{f ( σ ) - sign ( {V}_{1}^{*} ) \vert {i}_{l} \vert}{{V}_{2} + sign ( {V}_{1}^{*} ) ( {V}_{1}^{*} + σ )} .$$

where:

the sliding surface σ=\tilde{V}₁−sign(V₁*)V₂ and

f: a linear interpolation function;

V₁ and V₂: measured voltages;

V₁* and V₂*: reference voltages;

\tilde{V}₁ and \tilde{V}₂: voltage tracking error;

Advantageously, we have:

f(σ)=k₁a tan(k₂σ)

k₁=(R|V₂|+δ)

where:

k₁ and k₂ are positive adjustment constants;

δ>0;

R=ωₛ/f( β̅₀);

β̅₀: equilibrium value of β₀;
β₀: control angle;
ωₛ: angular frequency of the network.

Preferably, the control law is determined from an approach of the “sliding mode” type.

### BRIEF DESCRIPTION OF THE DRAWINGS

FIG. 1 shows active power as a function of the transmission angle, for three different values of the amount of compensation.

FIG. 2 is the block diagram of the TCSC.

FIG. 3 shows the impedance of the TCSC as a function of trigger angle.

FIG. 4 illustrates the operation of the TCSC in capacitive mode.

FIG. 5 illustrates the operation of the TCSC in inductive mode.

FIG. 6 shows the current and voltage curves for the TCSC in capacitive mode.

FIG. 7 shows the system of the invention.

FIG. 8 shows the equivalent effective admittance of the TCSC as a function of the angle β, in a system of the prior art.

FIG. 9 illustrates dynamic behavior on the surface σ=0.

FIGS. 10 to 14 show comparative results obtained with the control law as defined in the document referenced [2] and with the control law of the invention.

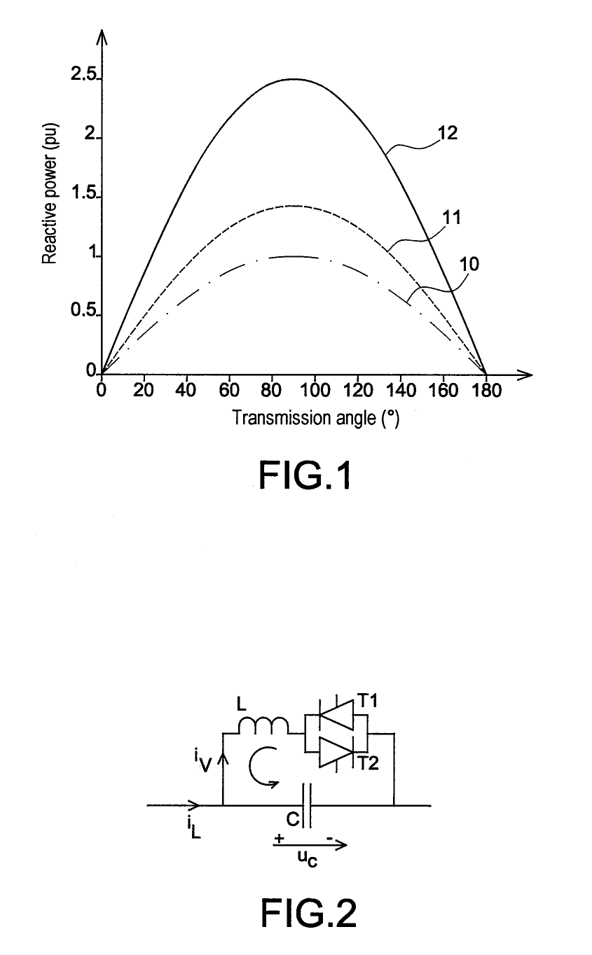

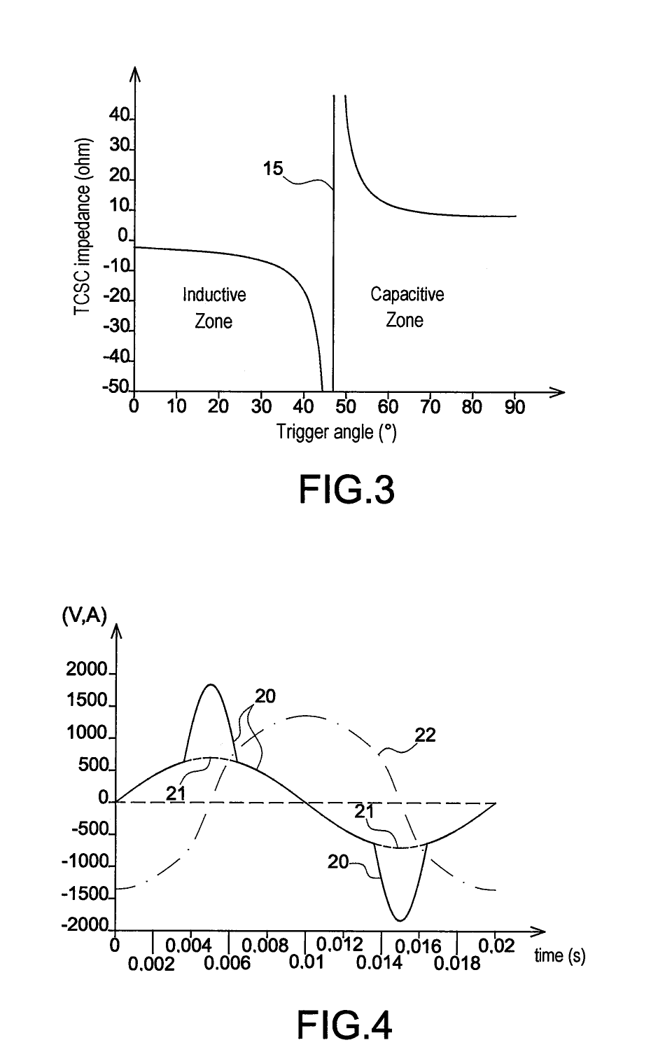

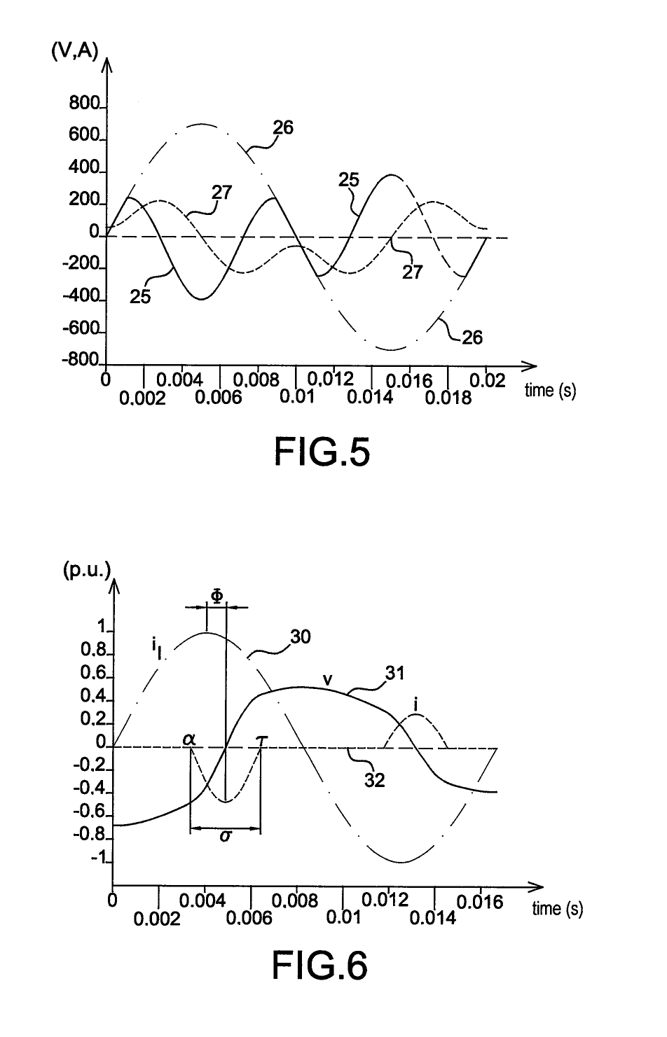

### DETAILED DESCRIPTION OF PARTICULAR EMBODIMENTS

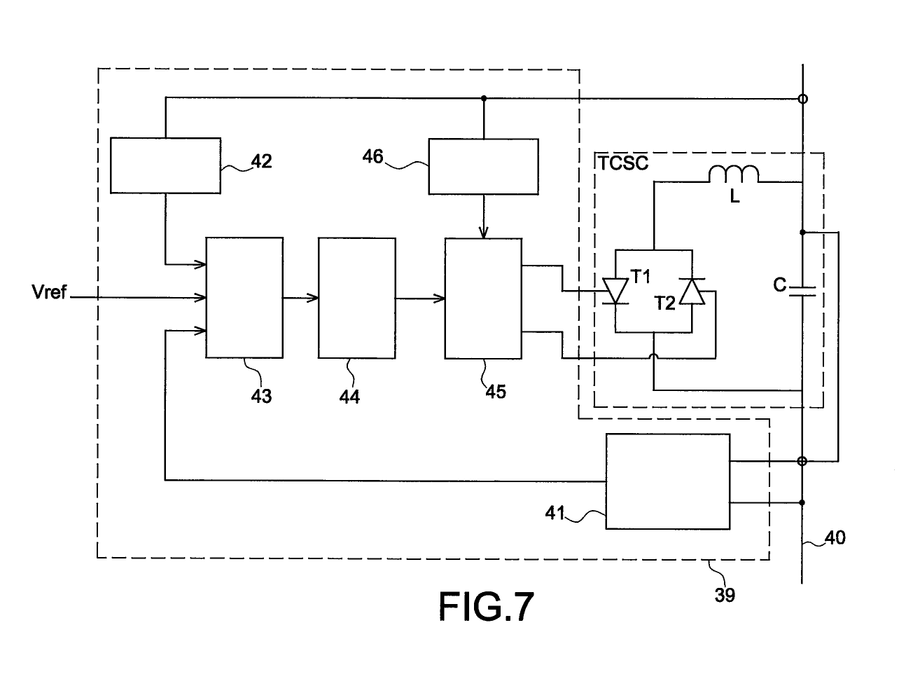

The control system for a TCSC in a power transmission network according to the invention is shown in FIG. 7. This TCSC, which is disposed on a high voltage line 40, comprises a capacitor C, an inductance L, and a set of two thyristors T1 and T2.

This control system 39 comprises the following:

a voltage measuring module 41 that enables the harmonics in the voltage across the TCSC to be extracted;

a current measuring module 42 that enables the amplitude of the fundamental, and optionally of other harmonics, of the current flowing in the high voltage line 40, to be extracted;

a regulator 43 that operates in accordance with a predetermined non-linear control law, and that receives on its input the output signals from the two modules 41 and 42 measuring voltage and current, and a reference voltage V_{ref} corresponding to the fundamental (harmonic 1 at 50 Hz) of the voltage that is to be obtained across the TCSC, the regulator delivering an equivalent effective admittance;

a module 44 for extracting the control angle in accordance with an angle extraction algorithm (for example a table, a modeling procedure, or a binary search), which receives the said equivalent effective admittance and delivers a control angle; and

a module 45 for controlling the thyristors T1 and T2 of the TCSC, which receives the said control angle and a zero current reference that is delivered by a phase-locked loop 46 giving the position of the current.

The method of controlling a TCSC disposed on the high voltage line of a power transmission network according to the invention accordingly comprises the following steps:

a voltage measuring step that enables the harmonics of the voltage across the TCSC to be extracted;

a current measuring step that enables the amplitude of the fundamental, and optionally of other harmonics, of the current flowing in the high voltage line to be extracted;

a step of regulation in accordance with a non-linear control law, making use of the voltage and current measuring signals and a voltage reference signal corresponding to the fundamental of the voltage that is to be obtained across the TCSC, whereby to obtain an equivalent effective admittance;

a step of extracting the control angle in accordance with an angle extraction algorithm, using the said equivalent effective admittance whereby to obtain a control angle; and

a step of controlling the thyristors of the TCSC using the said control angle together with a zero current reference that is delivered by a phase-locked loop giving the position of the current.

In order to describe the method of the invention more precisely, there follows an analysis in succession of a control law of the prior art, a first control law of the invention, and a second control law of the invention.

### Control Law of the Prior Art

A control law from the prior art, as described in the document referenced as [2], is now analyzed. This control law is obtained by making use of the theory of “sliding modes”.

Control by sliding modes, dedicated to the control of non-linear systems, is noted not only for its qualities of robustness, but also for the stresses which are imposed on the actuators. Adjustment of this kind of control system makes its industrial application difficult. In addition, there is no systematic method of design of a control system with sliding modes of any higher order at all.

The concept of control by sliding modes consists of two steps as follows:

(1) The system is put on a stable range of values that will satisfy the desired conditions (this is called “reaching phase”); and

(2) “Sliding” takes place on the “surface” thus defined, until the required equilibrium is obtained (this is called “sliding phase”).

By way of example, the following second order system is considered.

$$\{ \begin{matrix}{\dot{x}}_{1} = {x}_{2} \\ {\dot{x}}_{2} = f ( x ) + g ( x ) u\end{matrix}$$

The following assumptions are made:

f and g are non-linear functions;

g is positive.

This system is to be brought to equilibrium. The first step accordingly consists in constructing a stable range of values leading to the required equilibrium, as follows:

x₁ is stable if

\dot{x}₁=ax₁

where a>0 (or Re(a)>0 in the complex case in which Re=the real part).

It is then possible to define a coordinate relative to the stable values that gives us a set of surfaces that are defined as follows:

s=x₂±ax₁

We also have:

\dot{s}=\dot{x}₂+a\dot{x}₁

\dot{s}=f(x)+g(x)u+ax₂

The above system of equations is then stable on the surface s=0. Thus, once the system has been put on the said surface, it is certain to converge towards equilibrium.

It is therefore now necessary to make this surface attractive for the system. For this purpose, the arguments of Lassalle can be used. We have the following function:

V=½s²

This function is clearly zero at the origin, and positive everywhere else. Its time differential is given by the following:

\dot{V}=\dot{s}s

\dot{V}=s(f(x)+g(x)u+ax₂)

\dot{V} is defined as negative if:

f(x)+g(x)u+ax₂<0 for s>0

f(x)+g(x)u+ax₂=0 for s=0

f(x)+g(x)u+ax₂>0 for s<0

Stability is therefore ensured if:

u<β(x) for s>0

u=β(x) for s=0 β(x)=−[f(x)+ax₂]/g(x)

u>β(x) for s<0

This is ensured by the control law:

u=β(x)−K sign(s)

By applying this control law, convergence is then obtained towards the surface defined by s=0, which leads to the required equilibrium.

This theory of sliding modes is capable of being used in the quest for a new control system which is applicable to a TCSC. For the calculations of this control system, a simplified model of the TCSC is made use of, which is based on the following general model:

$$\{ \begin{matrix}C \frac{d V}{d t} = {I}_{l} - I - JC {ω}_{s} V \\ L \frac{d I}{d t} = {〈 qv 〉}_{1} - JL {ω}_{s} I\end{matrix}$$

By analysing the characteristic values of the linearised system, it is found that the dynamics of the phasers of current I are much larger than those of voltage V. The system can then be expressed as:

$$C \frac{d V}{d t} = {I}_{l} - J {ω}_{s} {C}_{eff} ( β ) V$$

$$where \text{:}$$

$$J = ( \begin{matrix}0 & - 1 \\ 1 & 0\end{matrix} ) , {I}_{l} = {[ 0 , - \vert {i}_{l} \vert ]}^{T} , V = {[ {V}_{1} , {V}_{2} ]}^{T}$$

The quantity β represents the half period of conduction, and C_{eff}(β) represents the effective capacitance in a quasi-steady conditions, and is given by the following formula:

$${C}_{eff} ( β ) = {\{ \frac{1}{C} - \frac{4}{π} [ \begin{matrix}\frac{1}{2 C} S ( β + \frac{sin ( 2 β )}{2} ) + \\ {ω}_{s}^{2} {LS}^{2} {cos}^{2} ( β ) ( tan ( β ) - η tan ( ηβ ) )\end{matrix} ] \}}^{- 1}$$

If greater precision is required, it is possible to take into account the phase shift angle Ø between the line current and the voltage in the TCSC. We then have:

β=β₀+ø

$$where φ = a tan ( \frac{{V}_{2}}{{V}_{1}} )$$

β₀ here designates the half conduction angle in quasi-steady conditions.

In order to separate Ø and β₀ from each other, the quantity Ø can be considered as being a known disturbance to be damped out.

The following approximation can then be made:

$${C}_{eff} ( β ) = {C}_{eff} ( {β}_{0} + φ )$$

$${C}_{eff} ( β ) = {C}_{eff} ( {β}_{0} ) + φ \frac{δ {C}_{eff}}{δβ} {\vert}_{{β}_{0}}$$

In the capacitive region:

$$f ( {β}_{0} ) {Δ}_{=} \frac{δ {C}_{eff}}{δβ} {\vert}_{{β}_{0}} < 0$$

Since we have ø<<<1, we can also obtain an approximation for ø in the following way:

$$φ = arctan ( - \frac{{V}_{2}}{{V}_{1}} )$$

$$φ ≃ - \frac{{V}_{2}}{{V}_{1}}$$

The equation for the system then becomes:

$$C \frac{d V}{d t} = {I}_{l} - J {ω}_{s} {C}_{eff} ( β ) V$$

$$C \frac{d V}{d t} ≃ {I}_{l} - J {ω}_{s} {C}_{eff} ( β ) V + J {ω}_{s} \frac{{V}_{2}}{{V}_{1}} f ( {β}_{0} ) V$$

The last term may also be written as follows:

$$J {ω}_{s} \frac{{V}_{2}}{{V}_{1}} f ( {β}_{0} ) V = {ω}_{s} \frac{{V}_{2}}{{V}_{1}} f ( {β}_{0} ) [ \begin{matrix}- {V}_{2} \\ {V}_{1}\end{matrix} ]$$

$$J {ω}_{s} \frac{{V}_{2}}{{V}_{1}} f ( {β}_{0} ) V = {ω}_{s} f ( {β}_{0} ) [ \begin{matrix}- \frac{{V}_{2}^{2}}{{V}_{1}^{2}} & 0 \\ 0 & 1\end{matrix} ] [ \begin{matrix}{V}_{1} \\ \\ {V}_{2}\end{matrix} ]$$

$${J}_{s} \frac{{V}_{2}}{{V}_{1}} f ( {β}_{0} ) V = K ( V , {β}_{0} ) V$$

The structure of the matrix K(V,β₀) shows that this non-linear term has a damping effect on the second line only (in capacitive mode). For this reason, the work on development of the control law is directed mainly to damping within the dynamic of V₁.

It may also be observed that K(V, β₀) depends on the state and the control of the system. In addition, the control angle β₀ is desired to be taken out or extracted by considering only C_{eff}(β₀) without having regard to its influence in K(V, β₀). It is therefore preferable to define a new control variable u=ωₛC_{eff}β₀), and to calculate u. From this it is then possible to deduce the angle β₀, for example by a binary search. If it is required to obtain the angle β₀ having regard to its effect both on K(V, β₀) and C_{eff}(β₀), the process becomes extremely complex.

In order to make the process of designing the control system easier and to remove the influence of the control signal in the term K(V, β₀)V, the evaluation of this term is made at the equilibrium point, which enables the following linear term to be obtained:

$$\begin{matrix}{ω}_{s} f ( {β}_{0} ) [ \begin{matrix}- \frac{{V}_{2}^{2}}{{V}_{1}^{2}} & 0 \\ 0 & 1\end{matrix} ] V \to - [ \begin{matrix}0 & 0 \\ 0 & {ω}_{s} \vert f ( {\overline{β}}_{0} ) \vert\end{matrix} ] V \\ = - K ( {\overline{β}}_{0} ) V\end{matrix}$$

where K is a positive semi-defined matrix, and the constant β̅₀ is the equilibrium value of β₀.

It is also noted that R=ωₛ|f(β₀)|

The system finally reduces to:

$$\{ \begin{matrix}C \frac{d}{d t} V = {I}_{l} - JuV - K ( {\overline{β}}_{0} ) V or \\ C \frac{d}{d t} {V}_{1} = {uV}_{2} \\ C \frac{d}{d t} {V}_{2} = - \vert {i}_{l} \vert - {uV}_{1} - {RV}_{2}\end{matrix}$$

It is now possible to proceed to the calculation of the control law in a more conventional way, since the damping effect appears explicitly in the model.

In order to calculate the control law, the object here is to find u, and then after that βₒ, such that V=[V₁,V₂]^{T} follows the reference V*=[V₁*,0]^{T}. It is assumed that the line current is sinusoidal, and follows the expression i₁(t)=|iₗ|sin(ωₛt), with the reference

$${V}_{1}^{*} = - \frac{\vert {i}_{l} \vert}{{u}^{*}} .$$

In this approach, a surface is defined which is a linear combination of the states, and it is then proved that this surface contains the desired equilibrium point, and that all of the trajectories converge towards equilibrium. It is then sufficient to make the surface so defined attractive by making use of a Lyapunov function.

A surface is defined in the following way:

σ=\tilde{V}₁+V₂
with \tilde{V}₁=V₁−V₁*

Such a surface represents the sum of the errors on the variables relating to state. It is therefore required to converge towards the surface σ*=0, corresponding to a sum of zero errors. We then have the following quadratic function:

$$H = \frac{C}{2} {σ}^{2}$$

The differential relative to time of this function H is given by:

\dot{H}=Cσ\dot{σ}

\dot{H}=Cσ({tilde over (\dot{V}₁+\dot{V}₂)

\dot{H}=Cσ(\dot{V}₁−\dot{V}₁*+\dot{V}₂)

\dot{H}=σ(C\dot{V}₁+C\dot{V}₂)

\dot{H}=σ(uV₂−uV₁−RV₂−|iₗ|)

In the case where the amplitude of the line current is known, the following control equations can be used:

$$u = \frac{f ( σ ) + \vert {i}_{l} \vert}{{V}_{2} - {V}_{1}}$$

$$u = \frac{f ( σ ) + \vert {i}_{l} \vert}{2 {V}_{2} - ( {V}_{1}^{*} + σ )}$$

where f is a function such that σ f (σ)<0, f(0)=0.
We then get:

\dot{H}=σ(f(σ)−RV₂)

\dot{H}=σf(σ)−RV₂²−R\tilde{V}₁V₂

An approximation of the “sign” function can be chosen for f, as follows:

f(σ)=−k₁a tan(k₂σ)

where k₁ and k₂ are positive adjustment constants.

By application of the above control function u, the surface σ=0 can then be made attractive. For this purpose it is necessary to render the expression for \dot{H} negative, by finding the appropriate gains k₁ and k₂. The true gain is k₁, and k₂ serves only to “flatten” the sign function about 0. By careful choice of a value for k₁, it is then possible to arrange that \dot{H}. remains negative regardless of what value is taken by the term −R\tilde{V}₁V₂.

Once the surface has been attained, it remains to verify the behaviour of the system on this surface, so as to ensure that it really does tend towards the equilibrium point (\tilde{V}₁*, V₂*)

The dynamic of the system on this surface is now analyzed.

On this surface the control u becomes:

$$u = \frac{f ( σ ) + \vert {i}_{l} \vert}{2 {V}_{2} - {V}_{1}^{*} - σ}$$

$$u = \frac{\vert {i}_{l} \vert}{2 {\tilde{V}}_{1} - {V}_{1}^{*}}$$

With this control, the dynamic of \tilde{V}₁, limited to σ=0, is given by:

$$C {\dot{\tilde{V}}}_{1} = {uV}_{2} = \frac{\vert {i}_{l} \vert {\tilde{V}}_{1}}{2 {\tilde{V}}_{1} + {V}_{1}^{*}} = \frac{\vert {i}_{l} \vert}{2} ( 1 - \frac{{V}_{1}^{*}}{2 {\tilde{V}}_{1} + {V}_{1}^{*}} )$$

The equilibrium of this dynamic is obtained for

$$\frac{{V}_{1}^{*}}{2 {\tilde{V}}_{1} + {V}_{1}^{*}} = 1 ,$$

and gives {tilde over ( V̅=0, which directly involves \tilde{V}₂=0 (by making ( .̅) as the value of (.) at equilibrium). The same exercise can be carried out on the dynamic of V₂. The second equilibrium point is then found in addition to the point (0,0). However, the dynamic of \tilde{V}₁ shows that the point (0, 0) is the sole general equilibrium point of the system, because as soon as V₂ is different from 0, this dynamic goes to the origin.

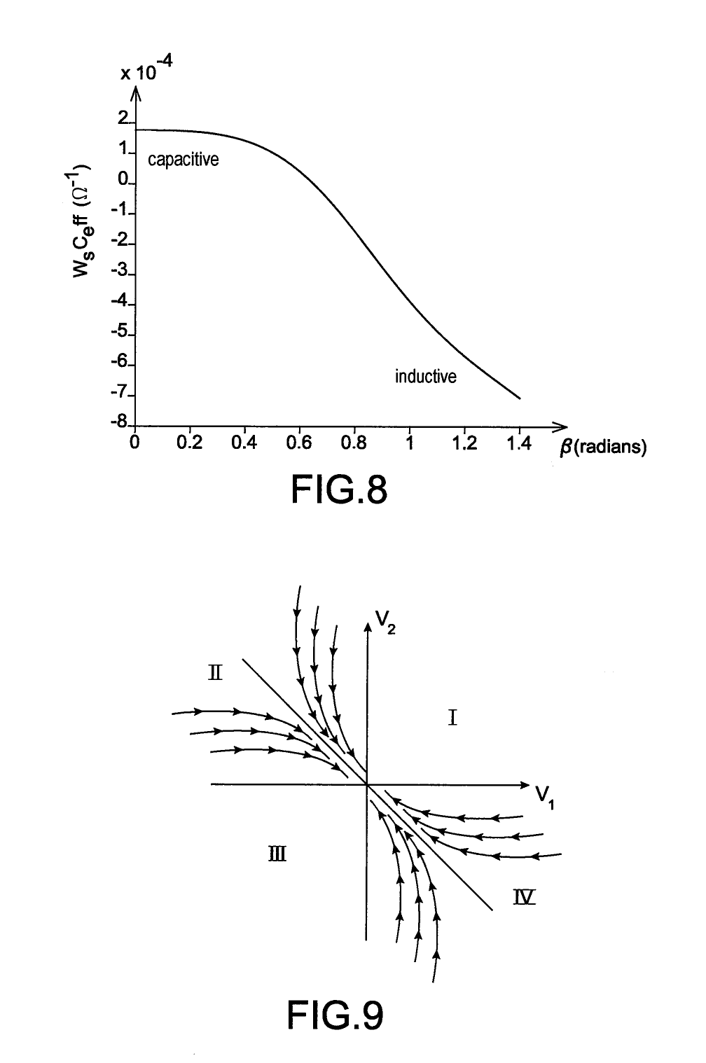

By limiting consideration to the capacitive regime, then u>0 as illustrated in FIG. 8. Then, when V₂<0, the equation C{tilde over (\dot{V}=uV₂ shows that {tilde over (\dot{V}₁<0, and conversely, when V₂>0, we have {tilde over (\dot{V}₁>0. We may then conclude that once on the surface σ=0, the control u definitely leads to the required equilibrium point, is shown in FIG. 9.

This method of control proves the most effective, both as far as robustness is concerned and as regards the dynamic, although no adjustment has been able to be found for k₁ and k₂ that would permit working in the inductive mode. As to this, and as was explained above, this control is valid only in the capacitive regime. In the inductive regime, we have u<0, and the reasoning which is set forth above is no longer applicable. In this regard it can be seen that this method of control, once on the surface, does not lead to its equilibrium state, because at present, when V₂<0, the equation C{tilde over (\dot{V}₁=uV₂ is such that {tilde over (\dot{V}₁>0, and conversely, when V₂>0, we have {tilde over (\dot{V}₁<0.

The object of the invention is to extend this control law into the inductive domain.

### Control Law of the Invention

In the above operation, the problem arises from the fact that, in the inductive mode, when V₂>0, \tilde{V}₁ decreases, and conversely, when V₂<0, \tilde{V}₁ increases.

If the surface s is so modified as to place it, this time, within the quadrants I and III in the plane of FIG. 9, the dynamic behaviour of the system on the surface being the same as in the capacitive mode, the control system will indeed then tend to the equilibrium point.

It is therefore proposed to repeat the same reasoning as for the capacitive mode, this time postulating that:

σ=\tilde{V}₁−V₂

Keeping the same Lyapunov function as before:

$$H = \frac{C}{2} {σ}^{2}$$

the derivative, this time, becomes:

\dot{H}=σ(uV₂+uV₁+RV₂+|iₗ|)

The command u to be employed is then given by the following:

$$u = \frac{f ( σ ) - \vert {i}_{l} \vert}{{V}_{2} - {V}_{1}}$$

$$u = \frac{f ( σ ) - \vert {i}_{l} \vert}{2 {V}_{2} - ( {V}_{1}^{*} + σ )}$$

The expression for \dot{H} then becomes:

\dot{H}=σ(f(σ)+RV₂)

In the same way as before, this expression can be made negative by manipulation of the function f(σ) on the gains.

The dynamic of the system on this new surface can then be analysed.

On this surface, the control u becomes:

$$u = \frac{f ( σ ) + \vert {i}_{l} \vert}{2 {V}_{2} - {V}_{1}^{*} + σ}$$

$$u = \frac{\vert {i}_{l} \vert}{2 {\tilde{V}}_{1} + {V}_{1}^{*}}$$

With this control u, the dynamic of \tilde{V}₁ limited to σ=0 is given by the following:

$$C {\dot{\tilde{V}}}_{1} = {uV}_{2} = \frac{\vert {i}_{l} \vert {\tilde{V}}_{1}}{2 {\tilde{V}}_{1} + {V}_{1}^{*}} = \frac{\vert {i}_{l} \vert}{2} ( 1 - \frac{{V}_{1}^{*}}{2 {\tilde{V}}_{1} + {V}_{1}^{*}} )$$

The origin then becomes the single equilibrium point.

As is shown in FIG. 8, u<0. Therefore when V₂<0, the equation C{tilde over (\dot{V}=uV₂ is such that {tilde over (\dot{V}₁>0, and conversely, when V₂>0, {tilde over (\dot{V}<0. It can then be concluded that, once on the surface σ=0, the control u does indeed tend towards the required equilibrium point.

In discussing the general case (i.e. capacitive+inductive), it is then possible to consider the following sliding surface:

σ=\tilde{V}₁−sign(V₁*)V₂

Since the general form of the derivative of the Lyapunov function is given by the equation:

\dot{H}=σ(f(σ)+sign(V₁*)RV₂

it can be written that the control u is given by the equation:

$$u = \frac{f ( σ ) - sign ( {V}_{1}^{*} ) \vert {i}_{l} \vert}{{V}_{2} + sign ( {V}_{1}^{*} ) ( {V}_{1}^{*} + σ )}$$

Accordingly, a control law has now been expressed which works equally well in both the capacitive mode and the inductive mode. It is now proposed to make this control easier and to optimise the control law which has been established.

### Optimising the Control Law of the Invention

We have a Lyapunov function, the general form of the derivative of which was given by the expression:

\dot{H}=σ(f(σ)+sign(V₁*)RV₂

The value of k₁ is now calculated such as to enable the term k₁a tan(k₂σ) to compensate for the term R\tilde{V}₁V₂, in such a way that the sum of these two terms remains negative (\dot{H}<0) whatever \tilde{V}₁ and V₂ are, so:

σ(f(σ)+sign(V₁*)RV₂)<0

Now the function a tan(k₂σ) is only an approximation of the function sign(σ), and therefore we get:

−k₁+sign(V₁*)RV₂<0
if σ>0

k₁+sign(V₁*)RV₂>0
if σ>0

It is then sufficient to choose the variable gain k₁=(R|V₂|+δ), where δ>0, in order to stabilise the origin asymptotically, that is to say in order to render the surface σ=0 attractive.

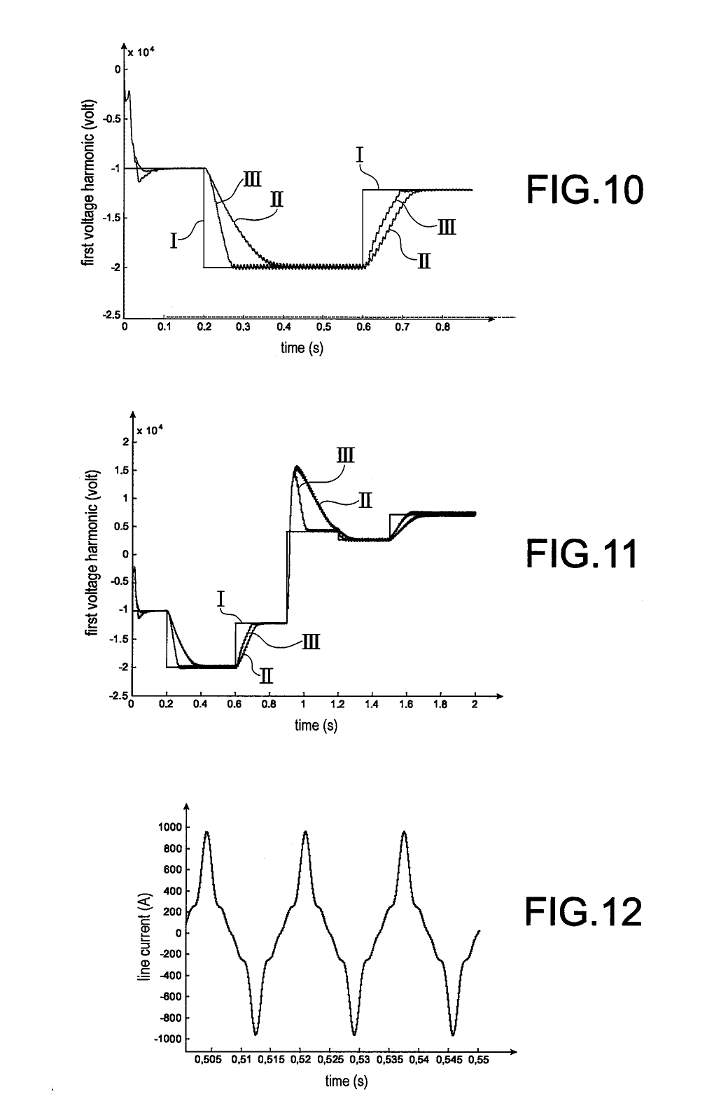

FIGS. 10 to 14 illustrate comparative results that are obtained with the control law of the prior art as defined in the document referenced [2], and with the control law of the invention.

FIG. 10 accordingly illustrates a method of operation without harmonics which is obtained in the capacitive mode with:

a curve I illustrating a reference signal;

a curve II obtained with the control law in the document referenced [2]; and

a curve III which illustrates the optimised control law of the invention.

As clearly appears in these curves, the dynamic of the control law of the invention is superior to that of the control law set forth in the document [2].

FIG. 11 shows the generalisation of the control law of the invention in the inductive mode, with operation in capacitive mode between 0 and 0.9 seconds and operation in the inductive mode between 0.9 seconds and 2 seconds.

Curve II illustrates the control law of the invention, which generalises the control law described in document [2] over the whole working range of the TCSC (in both the capacitive and inductive modes). Curve III illustrates the results which are obtained with the optimised control law of the invention (with variable gain).

FIG. 12 illustrates a line current which includes harmonics (30% harmonic 3, 20% harmonic 5, and 10% harmonic 7).

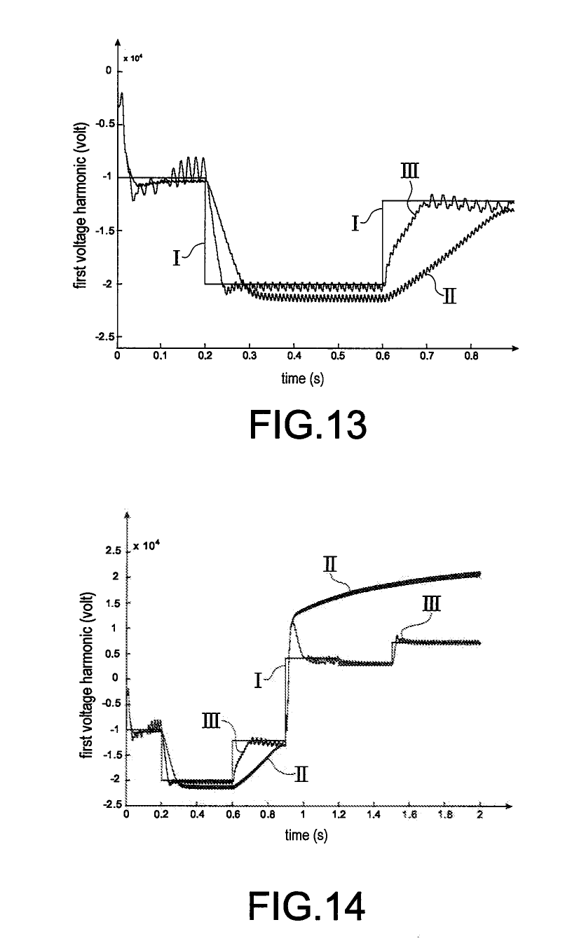

FIG. 13 then illustrates operation with such a line current in the capacitive mode. After comparison with the curve II obtained from document [2], it can be seen that the optimised control law of the invention (curve III) reduces static error and improves the dynamic (with more rapid convergence).

FIG. 14 illustrates operation with such a line current in both operating modes. Curve II illustrates the control law of the invention which generalizes the control law described in document [2], over the whole range of operation of the TCSC. It can be seen that the performance obtained in inductive mode, where severe harmonics occur, is not acceptable. In contrast, very satisfactory operation is obtained with the optimized control law of the invention as illustrated in curve III (with variable gain).

1. A control system for a TCSC disposed on a high voltage line of an electrical transmission network, which comprises:
a voltage measuring module which enables the harmonics of the voltage across the TCSC to be extracted;
a current measuring module which enables the amplitude of the fundamental, and any other harmonics, of the current flowing in the high voltage line to be extracted;
a regulator working in accordance with a non-linear control law, which receives as input the output signals from the two modules measuring voltage and current, and a reference voltage corresponding to the fundamental of the line voltage which is required to be obtained across the TCSC, the regulator delivering an equivalent effective admittance;
a module for extracting the control angle in accordance with an extraction algorithm which receives the said equivalent effective admittance and which delivers a control angle;
a module for control of the thyristors of the TCSC, which receives the said control angle and a zero current reference which is delivered by a phase-locked loop giving the position of the current,
wherein the control law is such that:
$$u = \frac{f ( σ ) - sign ( {V}_{1}^{*} ) \vert {i}_{l} \vert}{{V}_{2} + sign ( {V}_{1}^{*} ) ( {V}_{1}^{*} + σ )}$$
where:
the sliding surface σ=\tilde{V}₁−sign(V₁*)V₂ and
f: a linear interpolation function;
V₁ and V₂: measured voltages;
V₁* and V₂*: reference voltages,
\tilde{V}₁ and \tilde{V}₂: voltage following error.

2. A system according to claim 1, wherein the algorithm for extraction of the angle comprises a table, or a modelling process, or a binary search.

3. A system according to claim 1, wherein:
f(σ)=k₁a tan(k₂σ)
k₁=(R|V₂|+δ)
where:
k₁ and k₂ are positive adjustment constants;
δ>0;
R=ωₛ/f( β̅₀)
β̅₀: equilibrium value of β₀;
β₀: control angle;
ωₛ: frequency of the network.

4. A method of control of a TCSC disposed on a high voltage line of an electrical transmission network, which comprises the following steps:
a voltage measuring step which enables the harmonics of the voltage across the TCSC to be extracted;
a current measuring step which enables the amplitude of the fundamental and, optionally, those of any other harmonics in the current flowing in the high voltage line to be extracted;
a step of regulation in accordance with a non-linear control law, making use of the voltage and current measuring signals and a voltage reference signal corresponding to the fundamental of the line voltage that is required to be obtained across the TCSC, whereby to obtain an equivalent effective admittance;
a step of extracting the control angle in accordance with an angle extraction algorithm, using the said equivalent effective admittance whereby to obtain a control angle;
a step of controlling the thyristors of the TCSC, using the said control angle together with a zero current reference which is delivered by a phase-locked loop giving the position of the current,
wherein the control law is such that:
$$u = \frac{f ( σ ) - sign ( {V}_{1}^{*} ) \vert {i}_{l} \vert}{{V}_{2} + sign ( {V}_{1}^{*} ) ( {V}_{1}^{*} + σ )}$$
where:
the sliding surface σ=\tilde{V}₁−sign(V₁*)V₂ and
f: a linear interpolation function;
V₁ and V₂: measured voltages;
V₁* and V₂*: reference voltages,
\tilde{V}₁ and \tilde{V}₂: voltage following error.

5. A method according to claim 4, wherein the angle extraction algorithm is obtained by using a table, a modeling process, or a binary search.

6. A method according to claim 4, wherein the control law is determined from an approach making use of sliding modes.

7. A method according to claim 4, wherein:
f(σ)=k₁a tan(k₂σ)
k₁=(R|V₂|+δ)
where:
k₁ and k₂ are positive adjustment constants;
δ>0;
R=ωₛ/f( β̅₀)
β̅₀: equilibrium value of β₀;
β₀: control angle;
ωₛ: frequency of the network.
